(19) United States
(12) Patent Application Publication
(10) Pub. No.: US 2006/0162671 A1
(43) Pub. Date: Jul. 27, 2006

(54) Wild bird perch

(76) Inventor: Mary Victoria Neuer, Sharps Chapel, TN (US)

Correspondence Address: MONROE ALEX BROWN, P. O. BOX 70501, KNOXVILLE, TN, 37938-0501, US

(21) Appl. No.: 11/041,342

(22) Filed: Jan. 22, 2005

(51) Int. Cl. A01K 31/12

(52) U.S. Cl. 119/537

(57) ABSTRACT

The present invention discloses a novelly, bird-friendly, Bird Perch arrangement, system and assembly having, ideally, from one to four perch subassemblies, and a support base designed to interact with various, upper support areas such as branches and lower supported members such as conventional bird feeders. Each of the subassemblies is provided with main central portions which provide an arched flexible or solid support for special coiled portions which extend, preferably, in an outboard cascade or arrangement in relation to the support base. Each of the coils is constructed to be convoluted or inwardly coiling or arced, so that between 1 and 1.5 revolutions is achieved in relation to the beginning position of each coil.

### BACKGROUND OF THE INVENTION

1. Field of the Invention

The principal embodiment of the present invention relates to a bird perch device or apparatus, for providing a support system for wild and commercial pet birds which can be utilized in interaction with a support structure and a bird feeding structure; and in an additional embodiment of the present invention can be utilized in combination with an food/insect protector.

2. Background Information

Although no references were found specifically relating to the significant improvements that the present invention discloses and teaches in this technology; some of the references which disclose aspects of the general technology in this area germane to the present invention, with respect to which the Applicant is aware, include U.S. Pat. No. to Moulton, U.S. Pat. No. 15,982; Johnson, U.S. Pat. No. 1,248,337; Deibele, U.S. Pat. No. 1,786,704; Williams, U.S. Pat. No. 3,292,589; Kilham, U.S. Pat. No. 3,913,527; Palfalvy, U.S. Pat. No. 4,019,462; Sanford, U.S. Pat. No. 4,441,457; Mercil, U.S. Pat. No. 4,441,458; Bescherer, U.S. Pat. No. 5,062,390; Shaw, U.S. Pat. No. 5,507,249; Curts, U.S. Pat. No. 6,659,041; Liao, U.S. Pat. No. 5,842,305; Victor, U.S. Pat. No. 117,489; Grim, U.S. Pat. No. 118,852; Fredrickson, U.S. Pat. No. 882,306; Walter, U.S. Pat. No. 5,682,835; Hiday, U.S. Pat. No. 4,980,990; Heftier, U.S. Pat. No. 4,691,665; Miller, U.S. Pat. No. 4,030,451; Perkins, U.S. Pat. No. 3,979,854; Moody, U.S. Pat. No. 6,463,878; Hrebec, U.S. Pat. No. 4,217,723; McMahon, U.S. Pat. No. 6,443,095; Gilchrist, U.S. Pat. No. 5,823,135; Fisher, U.S. Pat. No. 6,318,290; Norman, Des. U.S. Pat. No. 360,496; Gilmore, U.S. Pat. No. 3,187,722; Meany, U.S. Pat. No. 2,591,459; Wydra, U.S. Pat. No. 6,662,747; Andrews, U.S. Pat. No. 1,769,408; Bard, U.S. Pat. No. 2,987,041; Engelking, U.S. Pat. No. 6,578,525 and U.S. Pat. No. 6,457,439; Gregory, U.S. Pat. No. 276,392; Lee, U.S. Pat. No. D371,227 and U.S. Pat. No. D371,226; and O'Rourke, U.S. Pat. No. 5,228,411.

The Engelking '525 patent reference discloses a Bird Perch Apparatus rotatably suspended from a bird cage ceiling, having two completely annular perch members which rotate in positional relation to two perpendicular axes. The Engelking '439 reference is similar to the '525 reference, adapted to be coupled to a support structure, and disclosing diametrically coupled annular rings acting as bird perch apparatus.

The Lee '226 reference discloses an ornamental design disclosing as a part thereof a full-circled ring, which relates positionally to other elements of a bird activity perch tree.

O'Rourke '411 discloses a Self-Supporting Cotton Bird Perch, adjustable within a bird cage. The cable utilized in the perch construction is meant to be utilized in various different configuration for bird support within a bird cage, including circular or arcuate configurations.

Sanford '457 discloses a Bird Feeder Stand adapted to support feeders having different sizes and shapes. This stand is provided with support arms attached to the invention's support post. The arms extend outwardly from the post and are adopted for cantilevered support of hanging types of bird feeders and watering devices.

Curts '041 discloses a Decorative Bird Feeder which in one embodiment is provided with what appears to be a curved framework structure. This structure, itself, however, even in this embodiment (other embodiments of this invention have dissimilar framework and decorative configurations) serves only to secure a container member therewithin and not to provide a perch means or element for supporting a bird, or doing so by any flexible arced and spired or looped means which functions separately from retaining a container or bird feed element. Curts is, otherwise, very different in function and structure from the present invention.

Gregory '392 discloses a bird perch having a non-flexible, partially arched Bird Perch device; and Marshall '054 discloses a Helical Perch Bird Feeder which structurally includes a container having feed-access openings and a generally helical member attached to the container to extend around it along a positional path such that for each of the openings, a portion of the helical member is close enough and in the proper location so as to allow a bird perched on that portion of the helical member to retrieve seed accessible through that opening to which it is juxtaposed. These functional and structural teachings in Marshall are in sharp contrast to those of the present invention.

None of the known patent references found in the prior art illustrate or disclose the flexible or rigid, spired bird perch array of the present invention. Nor is the present invention obvious, in this or known closely related technologies, in view of any of the prior art references listed. In addition, all of the prior art heretofore known suffer from several disadvantages.

A significant shortcoming in the prior art is that it does not offer a wild bird perch system which adequately simulates an array of tree branches, limbs or twigs, nor the characteristic configurational projections or flexibility or motion of such members. Nor does the prior art simulate such tree or bush members in advantageous positional relation to a source of food or to real tree or bush members.

Accordingly, the prior art suffers from not having a perch system whose parts/elements each provide desired pivotal or spring motion, or move as twigs, limbs or branches might move in response to weight bearing forces or the affects of ambient or environmental wind and weather.

The prior art also suffers from not providing a perch member, structure or array whose configuration(s) adequately simulate the convolutions or projections of a branch, twig or its members; thus having the effect of making a bird feel more comfortable in an environment closely akin to the bird's natural wooded or foliaged environment.

The prior art further suffers in not providing a more adequate array or system of bird perches in positional relation to one another; such that species of birds, many of whom are very social in nature, can frequent or use such a perch in closer or communicative positional relation to one another.

The prior art has the further disadvantage of not providing a more natural branch, limb or twig environment in advantageous positional relation to an insect protector; so that a food source near the perch or perch system can be more adequately protected from insects and wildlife, and be better preserved for consumption by bird populations.

These and other defects, problems and shortcomings of the prior art technology, structurally and functionally, will become apparent in reviewing the remainder of the present specification, claims and drawings.

Accordingly, it is an object of the present invention to provide a novel wild bird perch and bird perch array having flexibility, movement and configurational positioning; more adequately simulating a bird's natural socialization and feeding environment of trees, wooded areas and foliage.

It is a further object of the present invention to provide a base supported perch system which is coiled, convoluted or spired, and otherwise designed and positioned to extend downward and outboard to take advantage of the spring and biasing forces inherent in such a novel design and structural array.

It is a yet a further object of the present invention to provide a wild perch system which more adequately provides perch portions or members for socialization of birds; and which provides such a perch in a more advantageous position in relation to a food source.

It is a further object of the invention to provide, in preferred embodiments, an insect protector in more adequate positional relation to the perch system and a closely supported, adjacent food source area.

It will, therefore, be understood that substantial and distinguishable structural and functional advantages are realized in the present invention over the prior art teachings; and that the present invention's novel placement, configuration and array structure; diverse utility in serving to encourage socialization of birds while providing positional convenience in relation to a natural environmentally-friendly base support and feeding area; and the broad functional applications of the present invention; serve as important bases of novelty and distinction in this regard.

### SUMMARY OF THE INVENTION

The foregoing and other objects of the invention can be achieved with the present invention, device, assembly, system, and array; which is a wild bird perch array system for use in interaction with a tree, branch or other support area, and in interaction with a bird feeding member.

The invention is provided with a support base having an outer walled perimeter and upper and lower partitions; and one or more perch subassemblies. Each perch subassembly is comprised of a first extended portion, having a first spired end, a second spired end, and a central portion, therebetween. The central portion is attached to the outer walled perimeter of the support base, and is generally arched, arced, parabolic or hyperbolic in configuration, and positionally oriented so as to extend in a generally outboard direction in relation to the outer walled perimeter of the support base to which it is attached.

In preferred embodiments, each of the perch subassemblies is further provided with a second extended portion having first and second ends and a central perimeter therebetween. The first end thereof is concurrently attached to the central portion of the first extended portion, and the second end is provided with a spired end portion.

In preferred embodiments, each of the perch subassemblies is further provided with a third extended portion having first and second ends and a central perimeter therebetween. The first end thereof is concurrently attached to the central perimeter of said second extended portion, and the second end thereof is provided with a spired end portion.

### BRIEF DESCRIPTION OF THE DRAWINGS

FIG. 1 is a perspective view of the Wild Bird Perch, a preferred embodiment and example thereof, of the present invention; showing, additionally, by general two-dimensional illustrations, an example of the positional placement of birds with which the present invention interacts.

FIG. 2 is a side portion view of a preferred embodiment of a support member of the present invention.

FIG. 3 is a cross-sectional view taken along line 3-3 of FIG. 2.

FIG. 4 is a partially exploded cross-sectional view of the embodiment of FIG. 3

FIG. 5 is a side portion view of another preferred embodiment of the present invention.

FIG. 5A is a cross-sectional view of another preferred embodiment of the present invention's support base taken along line 5A-5A of FIG. 5.

FIG. 6 is a top view of the embodiment of FIG. 1 of the present invention.

FIG. 7 is a bottom view of the embodiment of FIG. 1.

FIG. 8 is a perspective view of the embodiment of FIG. 1, illustrating by general example the presence of wild birds, the limb of a tree and a bird feeding member, with which the present invention interacts, among many other examples of such items.

FIG. 9 is a perspective view of a preferred embodiment, illustrating a preferred angular and positional relationship between portions of the perch subassembly system of the present invention; and illustrating, by example, the positional flexibility thereof.

FIG. 10 is a perspective view of a preferred embodiment of the present invention, illustrating by example the dimensional positional relationship of portions of the preferred embodiment of the perch subassembly thereof.

FIG. 11 is a perspective view of a preferred embodiment of the present invention; illustrating, by example, the dimensionality of portions of the perch subassembly thereof.

FIG. 12 is a black and white photographic illustration showing a perspective view of another preferred embodiment of the present invention; and illustrating an exemplar positional relationship with wild birds, a section of an outdoor tree, and a bird feeding member; among many with which the present invention can interact.

FIG. 13 is a black and white photographic illustration, showing a close-up perspective view of the support base and upper portions of attached perch subassemblies of the embodiment of FIG. 12.

FIG. 14 is a black and white photographic illustration showing a further perspective view of the embodiment of FIG. 12 for further clarification and detail.

FIG. 15 is a black and white photographic illustration showing a close-up perspective view of bottom portions of the perch subassemblies of the embodiment of FIG. 12.

### REFERENCE NUMBERS

10 Wild Bird Perch, Bird Perch or Perch Of The Present Invention
12 support base
14 outer-walled perimeter or walling of (12)
16 upper partition surface of (12)
18 lower partition surface of (12)
20 perch subassembly
21 first extended portion of (20)
22 first coiled end of (21)
22A first arced portion of (22)
24 second coiled end of (21)
24A first arced portion of (24)
22A/24A imaginary tangent line (extending between and touching 22A and 24A)
26 central portion of (21)
28 second extended portion of (20)
30 first end of (28)
32 second end of (28)
34 central perimeter of (28)
36 coiled portion of (32)
24A/36A imaginary tangent line (extending between and touching 24A and 36A)
38 third extended portion of (20)
40 first end of (38)
42 second end of (38)
44 central perimeter of (38)
46 coiled portion of (42)
46A first arced portion of (46)
36A/46A imaginary tangent line (extending between and touching 36A and 46A)
50 second perch subassembly
51 first extended portion
52 first coiled end of (51)
54 second coiled end of (51)
56 central portion of (51)
58 second extended portion of (50)
58A first end of (58)
58B second end of (58)
58C central perimeter
58BP coiled portion of (58B)
59 third extended portion
59A first end of (59)
59B second end of (59)
59BP coiled portion of (59B)
59C central perimeter
60 third perch subassembly
61 first extended portion of (60)
62 first coiled end of (61)
64 second coiled end of (61)
66 central portion of (61)
68 second extended portion of (6o)
68A first end of (68)
68B second end of (68)
68C central perimeter of (68)
68BP coiled portion of (68B)
69 third extended portion of (60)
69A first end of (69)
69B second end of (69)
69BP P coiled portion of (69B)
69C central perimeter of (69)
70 fourth perch subassembly
71 first extended portion of (70)
72 first coiled end of (71)
74 second coiled end of (71)
76 central portion of (71)
78 second extended portion of (70)
78A first end of (78)
78B second end of (78)
78C central perimeter of (78)
78BP coiled portion of (78B)
79 third extended portion of (70)
79A first end of (79)
79B second end of (79)
79BP coiled portion of (79B)
79C central perimeter of (79)
80 first attachment member of (12)
81 branch of a tree (with which the invention interacts)
82 second attachment member of (12)
83 bird feeder (with which the invention interacts)
84 insect protecting trough portion of (12) (of a preferred embodiment of the invention
84A reservoir/trough area of (84)
84B central attachment portion of (84)
84C attachment bolt of (84)

### DETAILED DESCRIPTION OF THE PREFERRED EMBODIMENTS OF THE INVENTION

The following description of the preferred embodiments of the concepts and teachings of the present invention is made in reference to the accompanying figures which constitute preselected illustrated examples and photographic illustrations of the elements of the present invention, among many other examples existing within the scope and spirit of the present invention.

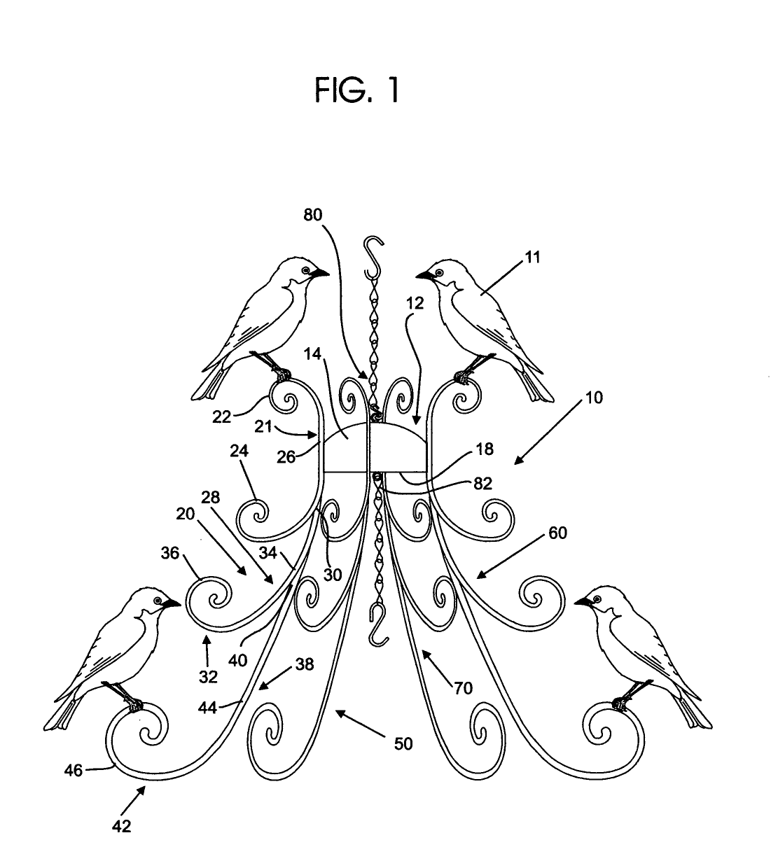

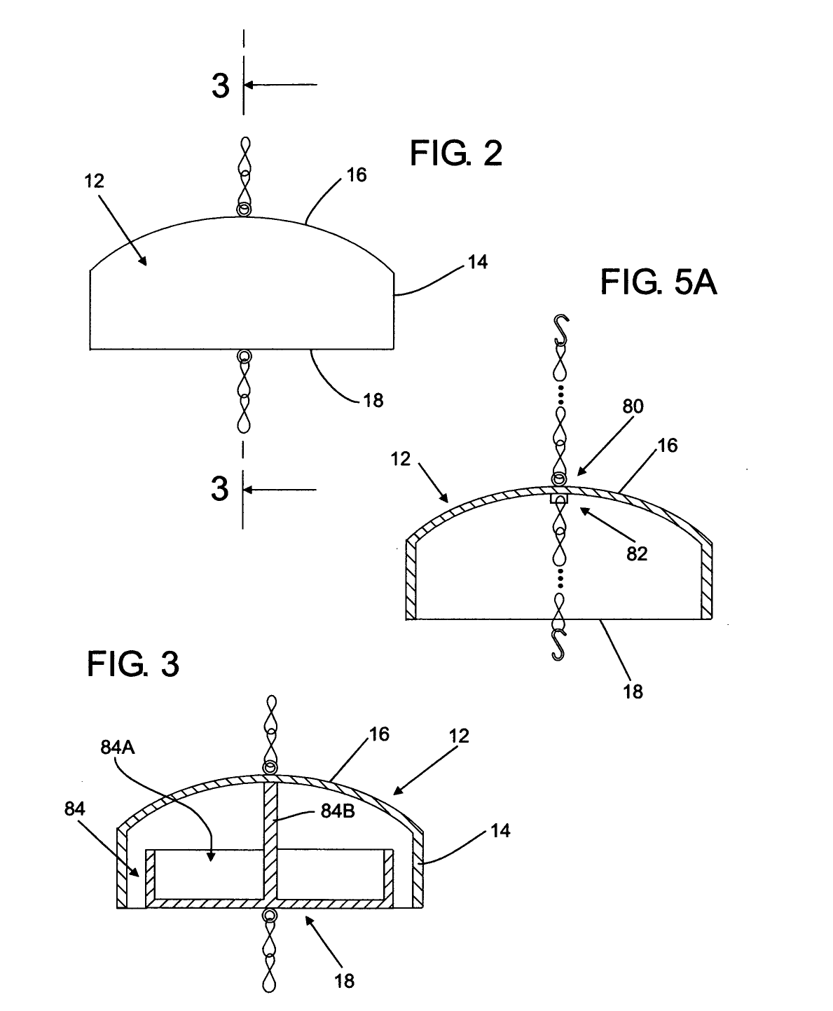

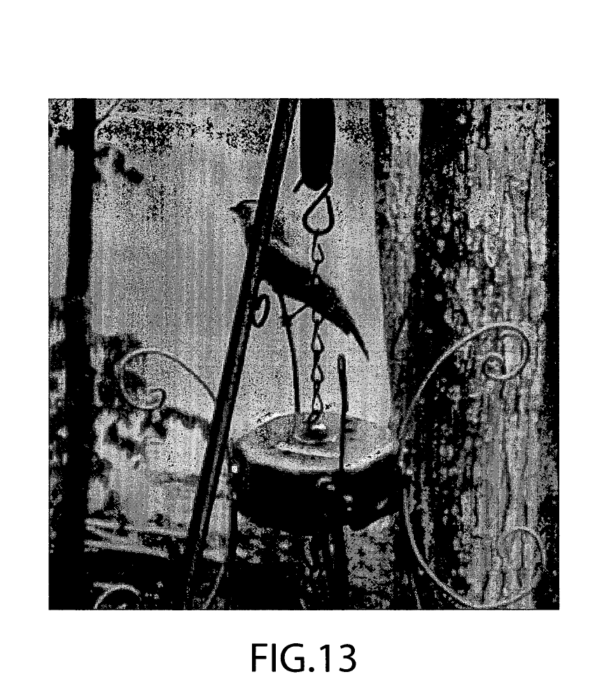

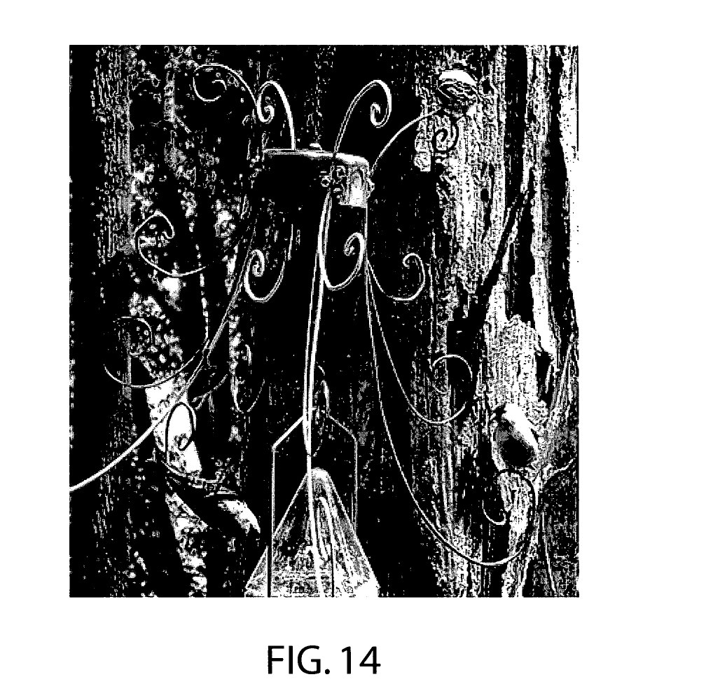

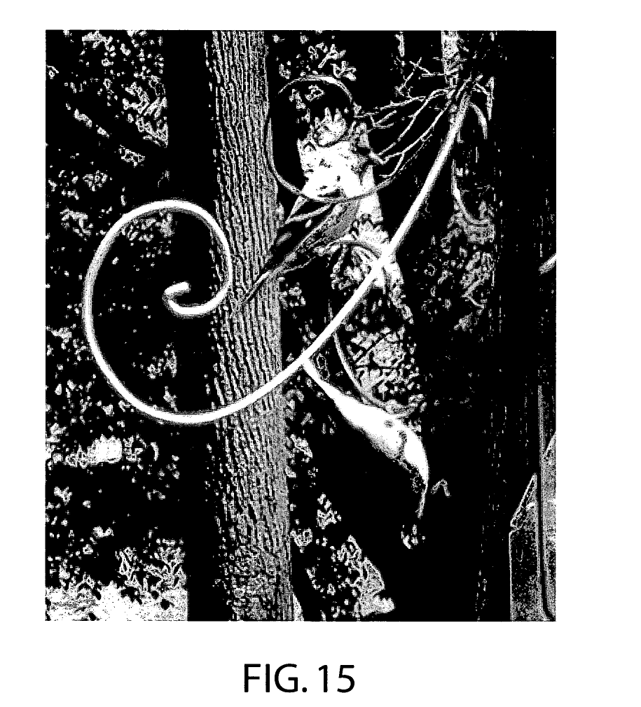

Referring now to the drawings, FIGS. 1 through 15, thereof; there is shown a Wild Bird Perch 10 of the present invention, referred to herein as the Bird Perch or Perch 10.

The Bird Perch 10 is utilized in providing a novel and realistic, bird-friendly environment for wild birds and like species; and, in preferred embodiments of the invention, utilized in interaction with various support members including branches or other support structures associated with a tree or heavy shrubbery; and various types of bird feeding members or structures; each of which is designed to be proximately positioned in relation to the Bird Perch 10 to enhance the environmental attraction to bird species.

It will be understood by those skilled in the art that there will be many ways in which the invention can be installed both indoors, under cover, and outdoors in relation to a ground site, trees or other flora; and many diverse support structures and feeding devices or means with which the present invention can interact.

The Bird Perch 10 is provided in a preferred embodiment with a support base 12. The base 12 is provided with an outer-walled perimeter or walling 14, and upper and lower partition surfaces 16 and 18, respectively, attached to the walling 14. Additionally, in preferred embodiments the Perch 10 is provided with at least one (1) perch subassembly 20.

The subassembly 20 is provided with at least the first extended portion 21. The portion 21 is provided with the first coiled end 22, the second coiled end 24, and a central portion 26 between the ends 22 and 24. The coiled ends 22 and 24 are each coiled, spired or convoluted; as illustrated, by examples, in FIGS. 1, 5, and 8 through 15. In preferred embodiments of the invention each of the coiled ends 22 and 24 is configurationally oriented in a curving arrangement rotating towards an imaginary axial portion, which will be discussed in more detail later herein.

The central portion 26 of the first extended portion 21 is attached or integrally connected to the outer-walled perimeter 14 of the support base 12. The central portion 26 is generally or substantially curved, arched or arced in its shape or configuration so as to extend in an outboard or outward direction, positionally, in relation to the outer-walled perimeter 14, when installed or attached as indicated; as illustrated, by example, in FIGS. 1 and 5, and other illustrations herein.

The perch subassembly 20, in preferred embodiments thereof, further includes the second extended portion 28, having the first and second ends 30 and 32 and its central perimeter 34 between these ends. The first end 30 is concurrently or integrally attached to the central portion 26 of the first extended portion 21. In this regard, in preferred embodiments, the first end is attached to the support base 12, while extending positionally, concurrently, or proximately with, the boundary of the central portion 26 of the first extended portion 21. The second end 32 is provided with, or defines, the coiled portion 36.

The perch 20, in preferred embodiments, further includes the third extended portion 38, having its first and second ends 40 and 42, respectively, and its central perimeter 44 connecting these ends. The first end 40 is concurrently or integrally attached to the central perimeter 34 of the second extended portion 26; or in preferred embodiments of the invention, to the support base 12 while extending along the boundaries, concurrently or proximately, with the central perimeter 34 of the second extended portion 28, and along the central portion 26 of the first extended portion 21. The second end 42 of the third extended portion 38 is provided with, or defines, the coiled portion 46.

All elements of the perch subassembly 20, in preferred embodiments; are shaped, configured or positionally attached; or placed to extend in an outboard, outer, or circumferentially outward angle or positioning, in relation to the outer-walled perimeter or walling 14 of the support base 12.

Further, in preferred embodiments of the present invention, as illustrated by example in FIGS. 1, 6, and 7 through 15; the Wild Bird Perch 10 is provided with a number or plurality of perch subassemblies having the elements of the subassembly 20. A preferred number of such perch subassemblies that has worked well in field experimentation, is four (4) such perch subassemblies. Accordingly, by example; the second, third and fourth perch subassemblies, 50, 60 and 70, respectively, are illustrated in the referenced Figures.

The support base 12 of the Perch 10 is further provided with the first attachment member, as illustrated by example in FIGS. 1 through 3, and 5A through 15; which is designed to interact with and attach to a support surface such as a branch of a tree 81, or any of a number of structures to which the first attachment 80 can be secured outdoors, indoors, or positionally under cover in an outside area. The attachment 80 can be fabricated of chain elements (as illustrated by example) or of any of a number of resilient flexible (elastic, extendable, bendable or positionable), or firm or solid (non-elastic) constructive materials.

Preferably, the first attachment 80 is attached or secured to an axial or intra-axial portion of the upper partition surface 16, as illustrated by example; although it will be recognized that it is within the scope and spirit of the present invention to position or support the attachment in various ways in positional relation to the outer-walled perimeter 14 and the upper partition surface 16 of the base 12.

The support base 12 is further provided with the second attachment member 82, which is designed to optionally or preselectively interact with and attach to a bird feeder 83, or like member or device, or other device or member designed to attract bird species. The attachment 82 is designed or fabricated as described regarding the attachment 80.

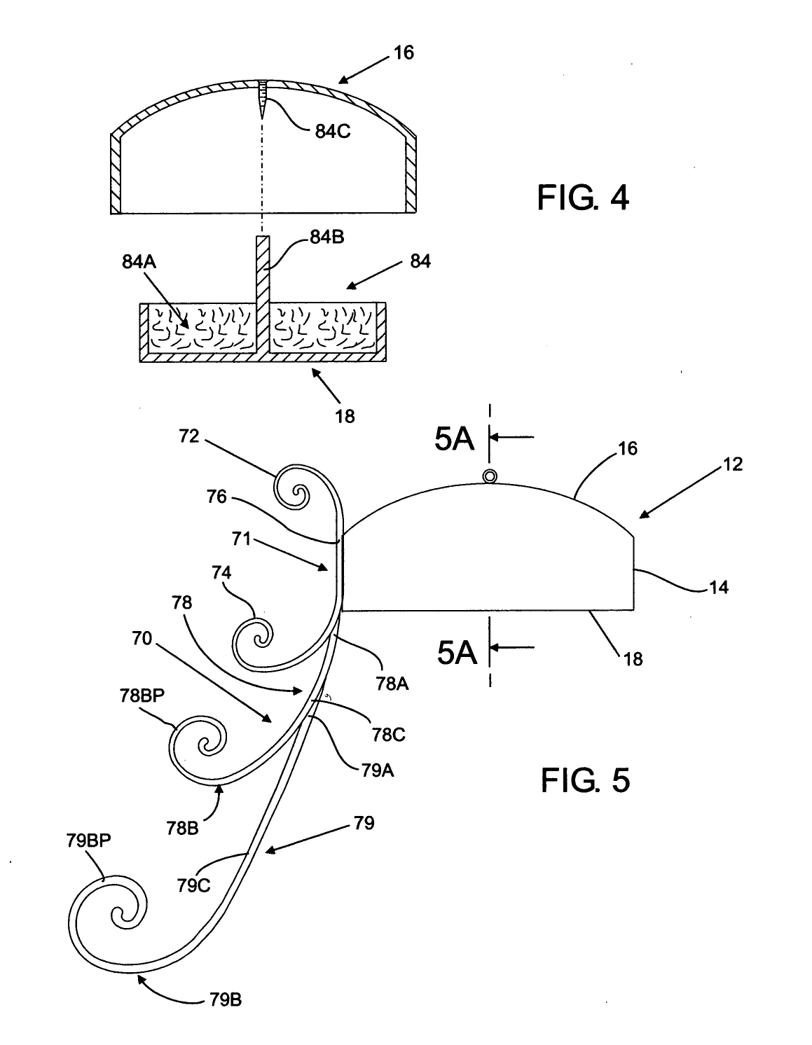

In other preferred embodiments of the invention the support base 12 houses and includes an insect protecting trough portion 84 for placement of water, or other liquid or fluid, within the base 12, to protect against insect migration to the perch subassemblies 20, 50, 60, and/or 70, and the bird feeder 83 (when utilized in interaction with the present invention); as illustrated by example in FIGS. 3 and 4. As illustrated by example, the trough portion 84 is provided with a reservoir/trough area 84A. It will be understood that the area 84A can be provided in many shapes and configurations as housed within the trough portion 84. The portion 84 is provided with a central attachment portion 84B. This area is axially or centrally bored and threaded to connect with or receive the attachment bolt 84C, extending from or through the surfaces 16 and/or 18 of the base 12; for securement, release and disengagement or uninstallment or removal, as desired by the user; as illustrated by example in FIG. 4.

It will otherwise be understood, that it is within the present invention's scope and spirit, for the attachment portion 84B and the trough portion 84 to be attached or secured to the outer-walled perimeter 14 and/or the upper partition surface 16 of the base 12 by a number of attachment or fixation means, for optional removal as desired.

Also, in preferred embodiments of the Perch 10, the support base 12 is provided as a hollow or solid base, where the first attachment member 80 is attached to the upper partition surface 16, and the second attachment member 82 is attached or secured to the lower partition surface 18; as illustrated by example in FIGS. 5 and 5A, and FIGS. 12 through 15.

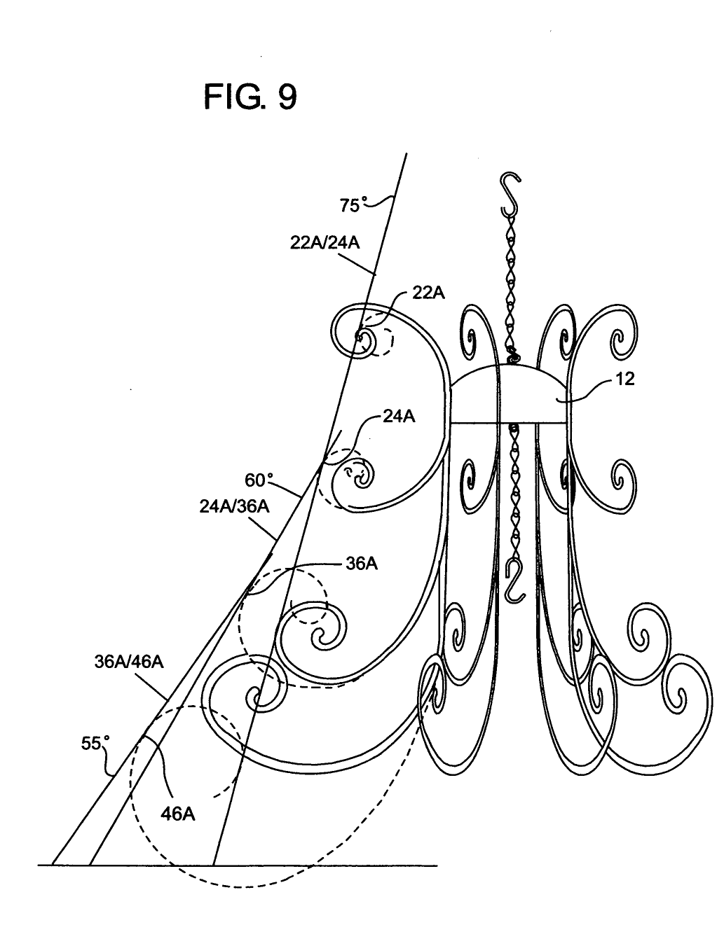

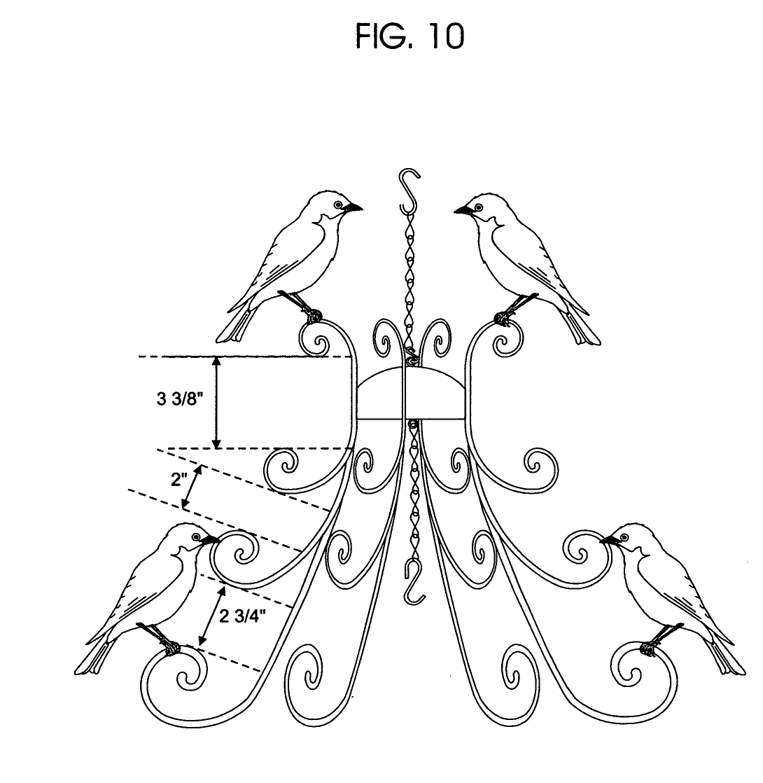

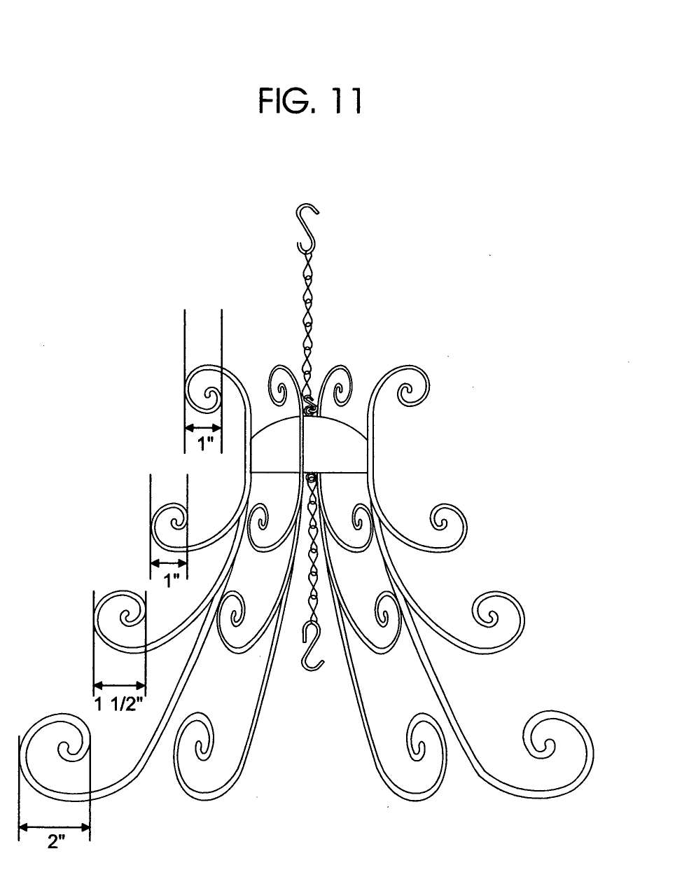

The central portions 26, 34, and 44, of each of the extended portions 21, 28 and 38, respectively, of the perch subassembly 20; of the present invention, in preferred embodiments thereof, are provided in an arced, arched, or parabolic configuration, as illustrated by example in FIGS. 9, 10 and 11. Or, in preferred embodiments these portions are provided in a hyperbolic configuration, as illustrated and disclosed by example, within the scope and spirit of the invention, in FIGS. 1, 5, 6, 7, 8, and 12 through 15.

As discussed earlier herein, the present invention of the Perch 10 is provided with at least the perch subassembly 20. However, in preferred embodiments of the invention the Perch 10 is provided, additionally, with the second perch subassembly 50, the third perch subassembly 60 and the fourth perch subassembly 70.

The second perch subassembly 50 is provided with the first extended portion 51 having its first coiled end 52, second coiled end 54 and central portion 56 between the ends 52 and 54; arranged and configured and attached as described in relation to the first extended portion 21, and its first and second coiled ends 22 and 24, discussed with regard to the perch subassembly 20. In like manner the central portion 56 is attached or secured to the outer walled perimeter or walling 14 of the support base 12; in the same manner as the central portion 26 is secured to the walling 14, as described and illustrated earlier herein.

The second perch subassembly 50 is further provided with the second extended portion 58, having its first and second ends 58A and 58B, and its central perimeter 58C. The second end 58B has and defines the coiled portion 58BP. These elements are arranged and configured and attached as described in relation to the second extended portion 28, and its first and second ends 30 and 32, the coiled portion 36, and the connecting central perimeter 34 of the second extended portion 28 of the perch subassembly 20.

Additionally, the perch subassembly 50 is provided with the third extended portion 59, having its first and second ends 59A and 59B. The second end 59B has and defines its coiled portion 59BP and the connecting central perimeter 59C. Each of these elements are arranged, configured and attached (integrally or proximately, as set forth); as described herein in relation to the first and second ends 40 and 42 thereof, the coiled portion 46, and the connecting central perimeter 44, of the third extended portion 38 of the perch subassembly 20.

In this regard, in preferred embodiments of the Perch 10, the first end 58A of the second extended portion 58 is attached to the central portion 56 of the first extended portion 51; and the first end 59A of the third extended portion 59 is attached to the central perimeter 58C of the second extended portion 58 in a manner so that a generally concurrent hyperbolic, or arched, configuration or shape is established in a portion of the connected first, second and third extended portions 51, 58 and 59; as illustrated in FIGS. 1, 5, 8, and 12 through 15. This, therefore, simulates or duplicates the same positional arrangement set forth in relation to the parallel elements discussed with regard to the first, second and third extended portions 21, 28 and 38 of the perch subassembly 20.

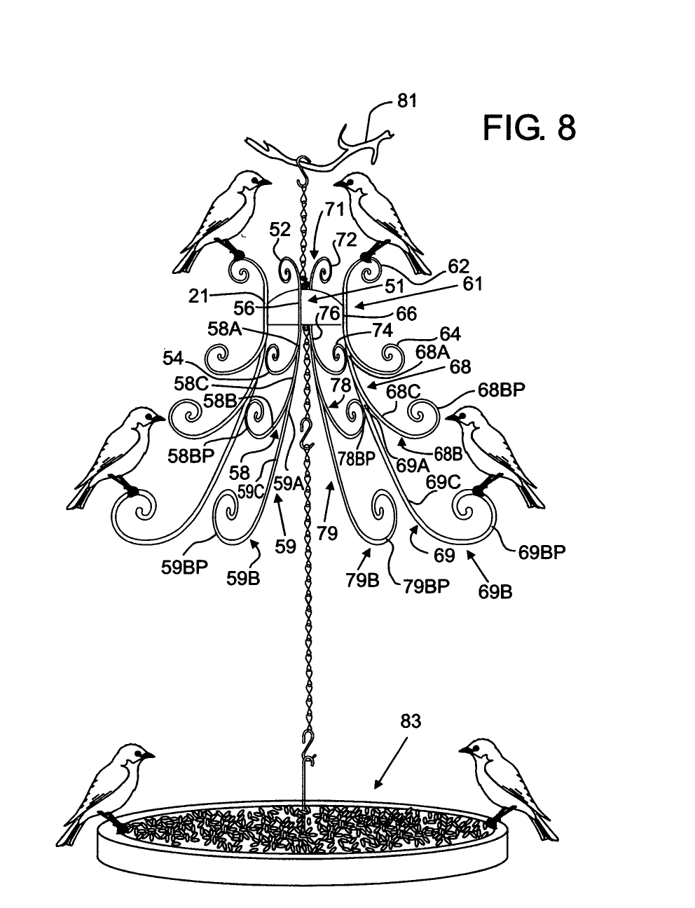

The third perch subassembly 60 is provided with the first extended portion 61 having its first coiled end 62, second coiled end 64 and central portion 66 between the ends 62 and 64; arranged and configured and attached as described in relation to the first extended portion 21, and its first and second coiled ends 22 and 24, discussed with regard to the perch subassembly 20. In like manner the central portion 66 is attached or secured to the outer walled perimeter or walling 14 of the support base 12; in the same manner as the central portion 26 is secured to the walling 14, as described and illustrated earlier herein; as illustrated, by example, in FIGS. 1, 8, and other illustrations.

The third perch subassembly 60 is further provided with the second extended portion 68, having its first and second ends 68A and 68B, and its central perimeter 68C. The second end 68B has and defines the coiled portion 68BP. These elements are arranged and configured and attached as described in relation to the second extended portion 28, and its first and second ends 30 and 32, the coiled portion 36, and the connecting central perimeter 34 of the second extended portion 28 of the perch subassembly 20.

Additionally, the perch subassembly 60 is provided with the third extended portion 69, having its first and second ends 69A and 69B. The second end 69B has and defines its coiled portion 69BP and the connecting central perimeter 69C. Each of these elements are arranged, configured and attached (integrally or proximately, as set forth); as described herein in relation to the first and second ends 40 and 42 thereof, the coiled portion 46, and the connecting central perimeter 44, of the third extended portion 38 of the perch subassembly 20.

In this regard, in preferred embodiments of the Perch 10, the first end 68A of the second extended portion 68 is attached to the central portion 66 of the first extended portion 61; and the first end 69A of the third extended portion 69 is attached to the central perimeter 68C of the second extended portion 68 in a manner so that a generally concurrent hyperbolic, or arched, configuration or shape is established in a portion of the connected first, second and third extended portions 61, 68 and 69; as illustrated in FIGS. 1, 5,8, and 12 through 15. This, therefore, simulates or duplicates the same positional arrangement set forth in relation to the parallel elements discussed with regard to the first, second and third extended portions 21,28 and 38 of the perch subassembly 20.

The fourth perch subassembly 70 is provided with the first extended portion 71 having its first coiled end 72, second coiled end 74 and central portion 76 between the ends 72 and 74; arranged and configured and attached as described in relation to the first extended portion 21, and its first and second coiled ends 22 and 24, discussed with regard to the perch subassembly 20. In like manner the central portion 76 is attached or secured to the outer walled perimeter or walling 14 of the support base 12; in the same manner as the central portion 26 is secured to the walling 14, as described and illustrated earlier herein; as illustrated, by example, in FIGS. 1, 8, and other illustrations.

The fourth perch subassembly 70 is further provided with the second extended portion 78, having its first and second ends 78A and 78B, and its central perimeter 78C. The second end 78B has and defines the coiled portion 78BP. These elements are arranged and configured and attached as described in relation to the second extended portion 28, and its first and second ends 30 and 32, the coiled portion 36, and the connecting central perimeter 34 of the second extended portion 28 of the perch subassembly 20.

Additionally, the perch subassembly 70 is provided with the third extended portion 79, having its first and second ends 79A and 79B. The second end 79B has and defines its coiled portion 79BP and the connecting central perimeter 79C. Each of these elements are arranged, configured and attached (integrally or proximately, as set forth); as described herein in relation to the first and second ends 40 and 42 thereof, the coiled portion 46, and the connecting central perimeter 44, of the third extended portion 38 of the perch subassembly 20.

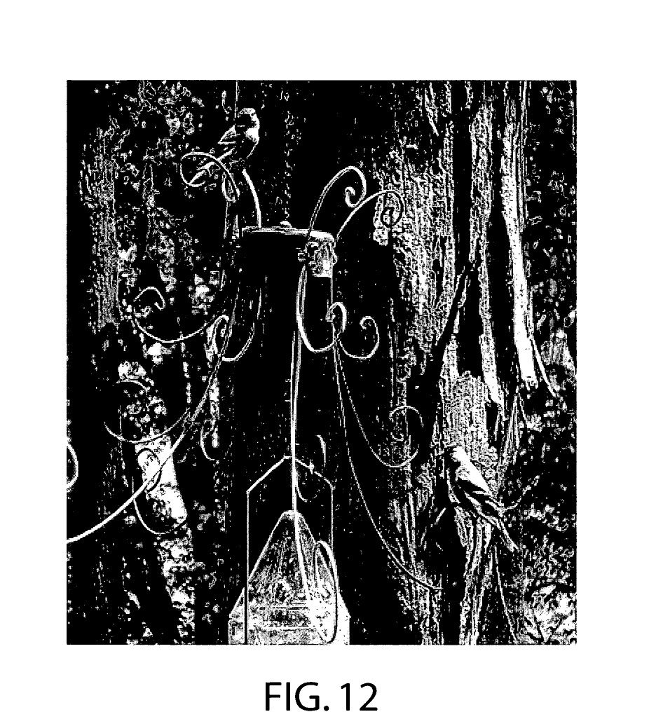

In this regard, in preferred embodiments of the Perch 10, the first end 78A of the second extended portion 78 is attached to the central portion 76 of the first extended portion 71; and the first end 79A of the third extended portion 79 is attached to the central perimeter 78C of the second extended portion 78 in a manner so that a generally concurrent hyperbolic, or arched, configuration or shape is established in a portion of the connected first, second and third extended portions 71, 78 and 79; as illustrated in FIGS. 1, 5, 8, and 12 through 15. This, therefore, simulates or duplicates the same positional arrangement set forth in relation to the parallel elements discussed with regard to the first, second and third extended portions 21, 28 and 38 of the perch subassembly 20. In FIGS. 1, 5, and 6 through 8, these positional relationships are illustrated by example by virtue of an integrally oriented connection. While in FIGS. 12 through 15, these positional relationships are illustrated by virtue of co-extending or concurrent orientation of one or more of portions or elements of the first, second and third extended portions 71, 78 and 79 being positioned and attached in a side-by-side or proximate relation to one another. This is true with regard to all of the parallel elements set forth and discussed herein with regard to the perch subassemblies 20, 50, 60 and 70.

In preferred embodiments, the positioning of various central portions of the first, second and third extended portions of the perch subassemblies 20, 50, 60 and 70 is, therefore, linked integrally or in side-by-side positioning, so that, preferably, in their initial positioning, a hyperbolic or hyperbola-oriented positioning is established. However, since, in preferred embodiments, the perch subassemblies are fabricated or constructed of resilient, but flexible or elastic, material; it will be understood, in response to environmental installation conditions or shipment packing, that the shape and configuration of the subassemblies can present themselves or be oriented to or in an arched, arced or parabolic (parabola-oriented) shape; which, in accordance with ambient conditions can change. This relationship is, in part, disclosed and illustrated in FIGS. 9, 10 and 11; showing, by example, a compressed position and an extended position by virtue of flexibility or elasticity of constructive components. It will be understood, within the spirit and scope of the present invention, that other arced, arched, or extended or contracted, curved positionings, may manifest themselves, and are possible, with respect to the shape of the various central portions of the perch subassemblies, and the shape of each of the subassemblies themselves, when in installed or actively used position. Additionally, the shape would be expected to change at least to some degree in response to weight-bearing loads provided by the birds, themselves, with whom the present invention is designed to interact.

As discussed in parts herein, each of the coiled ends or portions; 22 and 24 (first extended portion 21), 36 (second extended portion 28), and 46 (third extended portion 38) of the perch subassembly 20: and the corresponding elements 52 and 54 (first extended portion 51), 58BP (second extended portion 58) and 59BP (third extended portion 59) each of the second perch subassembly 50; the corresponding elements 62 and 64 (first extended portion 61), 68BP (second extended portion 68) and 69BP (third extended portion 69) each of the third perch subassembly 60; and the corresponding elements 72 and 74 (first extended portion 71), 78BP (second extended portion 78) and 79BP (third extended portion 79) each of the fourth perch subassembly 70; is provided with a spiraled (or coiled/convoluted) construction and configuration, having its first arced or curved portion and additional arced or curved portions, and coiling in a manner where the arced portions lead to a positional orientation which is inboard or inside the first arced portion (whether above or below thereof) and generally proximate to an axis of the first arced portion. This positional relationship is illustrated, by example, in FIGS. 1, 5, and 6 through 15.

Accordingly, in FIGS. 5 and 9, one finds illustrated, by example, the first arced portion 22A of the first coiled end 22 and the first arced portion 24A of the second coiled end 24 (each of the first extended portion 21), the first coiled portion 36A of the coiled portion 36 (of the second extended portion 28), and the first coiled portion 46A of the coiled portion 46 (of the third extended portion 38); each, of the perch subassembly 20. As illustrated, this positional relationship, and the presence and provision of the coiled ends and members of the three (3) extended portions, carries over and is present in each of the perch subassemblies utilized in the present invention in relation to the support base 12. In preferred embodiments of the Perch 10 only one perch subassembly 20 is utilized. However, in other preferred embodiments, two or more subassemblies bearing the same elements and configurations, described herein with regard to the perch subassembly 20, are utilized. It is within the scope and spirit of the present invention to utilize one or more perch subassemblies; and one or more extended portions on each of the perch subassemblies utilized. In such a case, a preferred embodiment of the invention would have additional extended portions, similar to those of extended portions 21, 28 and/or 38.

In other additional preferred embodiments of the Perch 10, within the scope and spirit of the invention, a preferred positioning relationship between elements of the extended portions of the perch subassemblies; is illustrated, by example, in FIG. 9, in reference to the perch subassembly 20. As illustrated and disclosed therein, the first arced portion 22A of the first coiled end 22 and the first arced portion 24A of the second coiled end 24 bear a positional relationship to one another such that an imaginary tangent line 22A/24A (illustrated therein by example) intersects each of these portions at an angle of about 75 degrees.

Additionally, in this regard, the positional relationship between the first arced portion 24A of the second coiled end 24 of the first extended portion 21, and the first arced portion 36A of the coiled portion 36, of the second end 32 of the second extended portion 28 is such that an imaginary tangent line 24A/36A intersects each of these portions at an angle of about 60 degrees.

Also, along these same lines, the positional relationship between the first arced portion 36A of the second extended portion 28, and the first arced portion 46A of the coiled portion 46 of the second end 42 of the third extended portion 38 is such that an imaginary tangent line 36A/46A intersects these two portions at an angle of about 55 degrees.

Each of these relationships, as illustrated by example in FIG. 9, exists with regard to an initial, preferred installed position of the perch subassembly 20; and in preferred embodiments, the perch subassemblies 50, 60 and 70. Additionally, in this regard, FIG. 10, illustrates, by example, in a preferred embodiment, preferred dimensional relationships between portions of the first coiled end 22 and the second coiled end 24, the second coiled end 24 and the coiled portion 36, and the coiled portion 36 and the coiled portion 46. And FIG. 11 illustrates, by example, preferred dimensional relationships between arcuately or circumferentially related portions of each of the first and second coiled ends 22 and 24, the coiled portion 36, and the coiled portion 46.

The outer walled perimeter 14 of the support base 12 of the invention is illustrated, in preferred embodiments, as being generally round or circumferential, as shown by example in FIGS. 1 through 11. In other preferred embodiments, in part, the perimeter 14 is also utilized having an eight-sided (or octagonal) configuration, as illustrated by example in FIGS. 12 through 14. Other embodiments of the invention can also utilize a square, triangular or hexagonal configuration or orientation with regard to the perimeter 14. Additionally, the support base 12 can be fabricated from a number of resilient metals, metal alloys, laminates or polymers; and the constructive components of the various elements described herein with regard to the perch subassembly 20, and the other perch subassemblies 50, 6o and 70; can be constructed of flexible and resilient metal, metal alloy or polymer materials; or a diverse number of wire-type (or wiring) components, where the elements described herein are constructed integrally or in proximate positional relationship to one another, and in their attachment to the walled perimeter 14 of the support base 12. It will also be understood by those of reasonable skill in the art that the perch subassembly element described herein can be attached to the walled perimeter 14, or the partitions 16 and 18 by a number of releasable or permanently fixed means; including, but not limited to, screw or bolt/nut attachment means or through soldering or spot welding procedures; and the elements described herein can also be fabricated in positionally oriented as described in relation to one another by integral fabrication, construction or manufacture.

In preferred embodiments of the present invention, the perch subassembly 20 is provided with the extension portions 21, 28, and 38 being constructed and dimensioned so that the central perimeter 34 of the second extended portion 28 is longer dimensionally than the central portion 26 of the first extended portion 21, and the central perimeter 44 of the third extended portion 38 is longer dimensionally than the central perimeter 34 of the second extended portion 28.

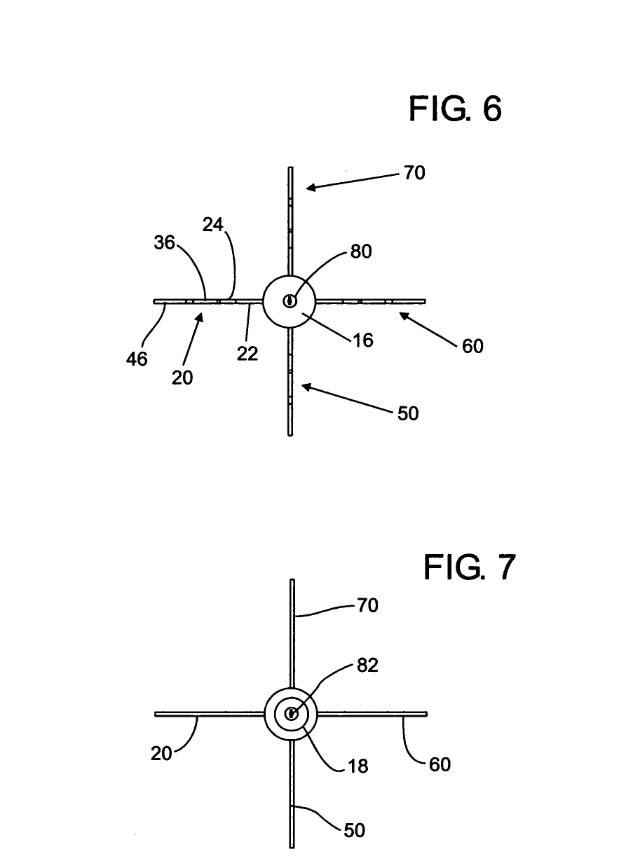

Additionally, when a plurality or number of perch subassemblies are employed in preferred embodiments of the Perch 10; as in the case of four (4) such perch subassemblies (20, 50, 60 and 70) described herein in a preferred embodiment, it is preferred to space the attachment of such perch subassemblies so that they are generally, evenly spaced from one another, as shown by example in FIGS. 6 and 7. It is within the scope and spirit of the invention to utilize other spacial relationships with regard to the supported perch subassemblies when a plurality of them is utilized.

Accordingly, the appended claims are intended to cover all changes, modifications and alterative options and embodiments falling within the true breath, scope and spirit of the present invention. The reader is, therefore, requested to determine the scope of the present invention by the appended claims and their legal equivalents, and not by the examples which have been given.

I claim:

1. A wild bird perch system, comprising:
A support base having an outer walled perimeter, and upper and lower partition surfaces attached thereto; and
at least one perch subassembly,
the at least one perch subassembly comprising at least:
a first extended portion, having a first spired end, a second spired end, and a central portion, therebetween,
the central portion being attached to the outer walled perimeter of the support base, and being generally arched in configuration and positionally oriented so as to extend in a generally outboard direction in relation to said outer walled perimeter.

2. The wild bird perch system of claim 1, wherein:
the at least one perch subassembly further comprising:
a second extended portion having first and second ends and a central perimeter therebetween,
the first end being concurrently attached to the central portion of said first extended portion,
and the second end defining and having a spired end portion.

3. The wild bird perch system of claim 2, wherein:
the at least one perch subassembly further comprising:
a third extended portion having first and second ends and a central perimeter therebetween,
the first end being concurrently attached to the central perimeter of said second extended portion,
and the second end defining and having a spired end portion.

4. The wild bird perch system of claim 3, wherein:
the second spired end of said first extended portion being generally oriented in a position which is further outboard in positional magnitude and distance than the first spired end thereof, in relation to the outer walled perimeter of said support base,
the spired end portion of the second end of said second extended portion being generally oriented in a position which is further outboard in positional magnitude and distance than the second spired end of the first extended portion, and
the spired end portion of the second end of said third extended portion being generally oriented in a position which is further outboard in positional magnitude and distance than the spired end portion of the second extended portion.

5. The wild bird perch system of claim 3, wherein:
the wild perch system further comprises a plurality of perch subassemblies identical to the at least one perch subassembly, and being attached to the walled perimeter of the support base and positioned in spaced relation to one another.

6. The wild bird perch system of claim 3, wherein:
the support base further comprises a means of attachment to another structure, being positioned on the upper partition thereof,
and a means of attachment for a bird feeding member, being positioned on the lower partition thereof.

7. The wild bird perch system of claim 5, wherein:
the support base further comprises a means of attachment to another structure, being positioned on the upper partition thereof,
and a means of attachment for a bird feeding member, being positioned on the lower partition thereof.

8. The wild bird perch system of claim 7, wherein:
the second partition of said support base defines and has an insect protecting trough, having the capacity to contain and house water and other liquid insect preventatives.

9. The wild bird perch system of claim 5, wherein:
the central portion of said first extended portion being generally hyperbolic in configuration.

10. The wild bird perch system of claim 9, wherein:
the first end of the second extended portion is attached to the central portion of said first extended portion, and the first end of the third extended portion is attached to the central portion of the second extended portion so as to positionally define a concurrent hyperbolic configuration therewith.

11. A wild bird perch system, comprising:
A support base, having a walled perimeter and upper and lower partitions attached thereto; and
at least one perch subassembly,
the at least one perch subassembly comprising:
a first extended portion, comprising a first spiraled end extension, having first and further arced portions; a second spiraled end extension, having first and further arced portions; and a central portion, having first and second ends, therebetween;
the first arced portion of said first spiraled end extension being connected to the first end of said central portion, and
the first arced portion of said second spiraled end extension being connected to the second end of said central portion;
an imaginary tangent line forming an angle of from about 65 degrees to about 85 degrees between the first arced portion of the first spiraled end extension and the first arced portion of the second spiraled end extension;
the central portion being generally hyperbolic in configuration, and being attached to the support base.

12. The wild bird perch system of claim 11, wherein:
the at least one perch subassembly further comprising:
a second extended portion having first and second ends and a central perimeter therebetween,
the first end being concurrently attached to the central portion of said first extended portion,
the second end defining and having a spiraled end portion, having first and further arced portions;
an imaginary tangent line forming an angle of from about 50 degrees to about 70 degrees between the first arced portion of the second spiraled end extension of the first extended portion and the spired end portion of the second extended portion.

13. The wild bird perch system of claim 12, wherein:
the at least one perch subassembly further comprising:
a third extended portion having first and second ends and a central perimeter therebetween,
the first end being concurrently attached to the central perimeter of said second extended portion, and
the second end defining and having a spiraled end portion, having first and further arced portions
an imaginary tangent line forming an angle of from about 45 degrees to about 65 degrees between the first arced portion of the spired end portion of the second extended portion and the first arced portion of the spired end portion of said third extended portion.

14. The wild bird perch system of claim 13, wherein:
the configuration of the at least one perch subassembly, between the first spiraled end extension of said first extended portion and the spiraled end portion of the second extended portion is generally hyperbolic; and the configuration of the at least one perch subassembly, between the first spiraled end extension of the first extended portion and the spiraled end extension of the third extended portion is generally hyperbolic.

15. A bird perch for simulating a bird's natural environmental perching options, and functioning in interaction with a support structure and a feeding source in adjacent positional relation thereto, said bird perch comprising:
a base support having perimeter side-walling and adjacent outer and inner surfaces, the outer surface having means for attaching to a support structure, the inner surface having means for attaching to a bird feeding or food source structure; and
a first perch subassembly, having first, second and third extension members,
the first extension comprising a central member having first and second ends, the first end defining and having a coiled portion having a plurality of convolutions, and the second end defining and having a coiled portion having a plurality of convolutions, the central member of said first extension being fixedly attached to the perimeter side-walling of the support base,
the second extension comprising a central member having first and second ends, said central member having a dimensional magnitude greater than that of the central member of the first extension, the second end defining and having a coiled portion having a plurality of convolutions, the first end being attached to the perimeter side-walling of the base support so as to position a dimensional part of the central member of said second extension in concurrent adjacent positional relation with a portion of the central member of the first extension, and
the third extension comprising a central member having first and second ends, said central member having a dimensional magnitude greater than that of the central member of the second extension, the second end defining and having a coiled portion having a plurality of convolutions, the first end being attached to the perimeter side-walling of the support base so as to position portions of the central member of said third extension in concurrent adjacent positional relation with portions of the central member of the first extension and the central member of the second extension.

16. The bird perch of claim 15,
further comprising: a second perch subassembly having all of the elements of the first perch subassembly, and being attached in the same manner to the support base, being so attached in spaced relation to the first perch subassembly.

17. The bird perch of claim 16,
further comprising: a third perch subassembly having all of the elements of the first perch subassembly, and being attached in the same manner to the support base, being so attached in spaced relation to the second perch subassembly and the first perch subassembly.

18. The bird perch of claim 17,
further comprising: a fourth perch subassembly having all of the elements of the first perch subassembly, and being attached in the same manner to the support base, being so attached in spaced relation to the first, second and third perch subassemblies.

19. The bird perch of claim 16, wherein:
the first perch subassembly is fabricated from a flexible material such elements thereof, and the first perch subassembly itself, bias and bounce in response to weight bearing forces.

20. The bird perch of claim 18, wherein:
the first, second, third and fourth perch subassemblies are, each, fabricated from a flexible material so that elements thereof bias and bounce in response to weight bearing forces.
